(19) United States
(12) Patent Application Publication
(10) Pub. No.: US 2004/0120796 A1
(43) Pub. Date: Jun. 24, 2004

(54) Device and method for handling flat wire binding element preforms

(76) Inventors: Albert Rieger, Geislingen (DE); Manfred Amrhein, Geislingen (DE); Alexander Hirsch, Kirchheim (DE); Mario Litsche, Backnang (DE); Harald Mauz, Ehingen (DE); Hans-Peter Wurschum, Ostfildern (DE)

Correspondence Address: Kevin L. Leffel, Heidelberg Digital L.L.C., 2600 Manitou Road, Rochester, NY, 14624, US

(21) Appl. No.: 10/677,599

(22) Filed: Oct. 2, 2003

(30) Foreign Application Priority Data
Oct. 2, 2002 (DE) 102 46 074.4

(51) Int. Cl. B42B 5/08

(52) U.S. Cl. 412/38

(57) ABSTRACT

The invention relates to a device and a method for handling flat wire binding element preforms, whereby the wire binding element preforms represent wire binding element semi-finished products. These types of wire binding elements are typically used in binding devices for loose binding of brochures consisting of several sheet-shaped materials using wire comb binding. According to various aspects of the invention, methods and devices are provided for accepting a flat wire binding element preform from a feed, transporting the flat wire binding element preform, and inserting the flat wire binding element preforms into a row of perforations in a stack of sheet-shaped print materials.

### BACKGROUND

The invention relates to a device and a method for handling flat wire binding element preforms, whereby the wire binding element preforms represent wire binding element semi-finished products. These types of wire binding elements are typically used in binding devices for loose binding of brochures consisting of several sheet-shaped materials using wire comb binding.

The term Wire-O® wire binding elements is understood to mean wire loops S that are parallel to and at a distance from each other and have a wire length L, a loop spacing A and a wire diameter D. These are formed into a Wire-O® ring using suitable closing devices.

Generally, the wire binding elements are preformed and made available for such binding devices using the loop spacing, the loop length, etc. in order to take into consideration different binding requirements like thickness and format of the brochures. Devices that produce wire binding elements with different parameters like loop spacing, loop length and number of loops are part of the state of the art. However, to date, changing the parameters has required a considerable intervention into and alteration of the device for manufacturing the wire binding elements.

A process is known from DE 28 47 700 A1 for manufacturing a wire binding for blocks, etc., in which a supply of wire that is continuously drawn is formed into a wave-shaped body by bending it back and forth, whereby the wave-shaped wire body is then bent perpendicular to the plane of the waves into a C-shaped structure. Forming rollers with specified diameters are used for bending, so only wire binding elements with loop spacings and lengths that do not change can be manufactured.

Binding devices for producing brochures, that use so-called Wire-O®

wire binding elements in various sizes are known, e.g. from the European patent applications EP 0 095 243 and EP 0 095 245. Also, there is an overview of different binding methods in “Print Media Manual” by H. Kipphan, pages 861ff; Springer Verlag (2000).

The binding devices for the above-mentioned patent applications are designed such that the processing of preformed Wire-O® wire binding elements with various loop spacings and lengths is made possible.

Generally, the named devices have the disadvantage that, for binding brochures with different formats and thicknesses, the necessary wire binding elements have to be made available as several stocks of binding element that are already formed, e.g. as rolled material or as elements cut to binding length. In order to be able to bind these different brochure formats and thicknesses, a considerable number of supplies is already necessary. Therefore, generally several magazines with the necessary wire binding elements are made available, whereby the magazine can be changed manually or automatically. However, because of the three-dimensional shape of the previously bent wire binding elements, these magazines require a lot of space. In addition, such a magazine also represents an initial financial investment even though there is no assurance that all of the previously bent wire binding elements will actually be used later.

In the course of the binding process, these wire binding elements must be inserted into the row of perforations in the sheet-shaped materials that make up the brochures. Because of the considerable expansion of the stored wire binding elements and their bending properties and their large dimensional tolerance ranges in all three dimensions, the effort for automatic handling of these stored wire binding elements is not inconsiderable. This is especially true for the procedure of inserting the wire binding elements into the row of perforations in a brochure to be bound. In many of the apparatuses that can be obtained commercially, this insertion is still carried out manually, which is not economical with larger printing runs. In addition, there is the fact that frequently the previously bent wire binding elements that have been purchased are deformed due to transport damage, and these can also only be mounted manually since the machines actually provided for this only tolerate deformations to a limited extent.

In addition, during a format change of the brochures to be produced, the equipment for transport and processing have to be adapted to the requirements of the different wire binding elements. This changeover requires complicated designs of the transport and binding equipment and makes the binding process economical only if larger numbers of one brochure thickness are produced in one format. Therefore, smaller printing runs are not economical to produce and, as a result, require more time as a result of machine adaptation.

Because of the options that modern digital printing allows, the need for and the possibility of producing personalized books or books with very small print runs has grown, in the extreme case with the run of a single copy which is called “book on demand”.

Equipment for producing such personalized books or individual runs is known from U.S. Pat. No. 5,465,213 and is also described in “Print Media Manual” by H. Kipphan, pages 989, 999; Springer Verlag (2000). Even for this type of small print runs, it is necessary for books to be bound reliably and cost-effectively.

In a device that produces wire binding elements individually adapted to the dimensions of such a single book immediately before binding, especially by adaptation of loop length S of the wire loops, which corresponds to an adaptation of the wire binding element to the thickness of the brochures, and by adaptation of the number of loops within a wire binding element, which corresponds to an adaptation of the wire binding element to the length of the spine of the brochure, it is necessary to handle a wire binding element preform, namely to transport this wire binding element preform from the unit that makes the wire binding element preform available to the stack of sheet-shaped materials and then to insert the wire binding element preform into the holes of the stack of sheet-shaped materials.

### SUMMARY

According to various aspects of the invention, methods and devices are provided for accepting a flat wire binding element preform from a feed, transporting the flat wire binding element preform, and inserting the flat wire binding element preforms into a row of perforations in a stack of sheet-shaped print materials.

### BRIEF DESCRIPTION OF THE DRAWINGS

FIG. 1 presents a schematic representation of the device according to an aspect of the invention.

FIG. 2 presents a schematic representation of a section of a wire binding element preform.

FIG. 3 presents a schematic representation of a brochure bound with an individual wire binding element.

FIG. 4a presents a schematic representation of a brochure bound with individual wire binding elements;

FIG. 4b presents a schematic representation of a brochure bound with a number of wire binding elements.

FIG. 5 presents a schematic exploded view of a transport unit according to an aspect of the invention.

FIG. 6 presents a schematic representation of the intake area of a transport unit according to an aspect of the invention.

FIG. 7 presents a schematic representation of an insertion unit according to an aspect of the invention.

FIG. 8a presents a schematic exploded view of an insertion module of an insertion unit according to an aspect of the invention;

FIG. 8b presents an enlarged representation of a wire loop support element.

FIG. 9 presents a simplified schematic view of an insertion unit, according to an aspect of the invention.;

FIGS. 10-1 to 10-4 present schematic representations of the insertion of a wire binding element preform into the holes of a stack of sheet-shaped materials.

FIG. 11a presents a schematic representation of the of a short wire binding element preform.

FIG. 11b presents a schematic representation of the insertion of a wire binding element preform.

FIG. 12 presents a schematic representation of the insertion of a short wire binding element preform.

FIG. 12b presents a schematic representation of the insertion of a long wire binding element preform.

### DETAILED DESCRIPTION

According to the various aspects of the invention, methods and devices for handling flat wire binding element preforms are provided that can make it possible to transport a wire binding element preform quickly, reproducibly and reliably to a stack of sheet-shaped materials in a device for flexible binding of book blocks or brochures of different thicknesses by means of wire comb binding and then to insert the wire binding element preform into the holes of the stack of sheet-shaped materials. The unit that makes the wire binding element preform available may be, on one hand, a unit that makes the wire binding element preform available to the device according to the invention from a magazine. On the other hand, the unit that makes the wire binding element preform available may be a unit that produces the wire binding element preform immediately before that.

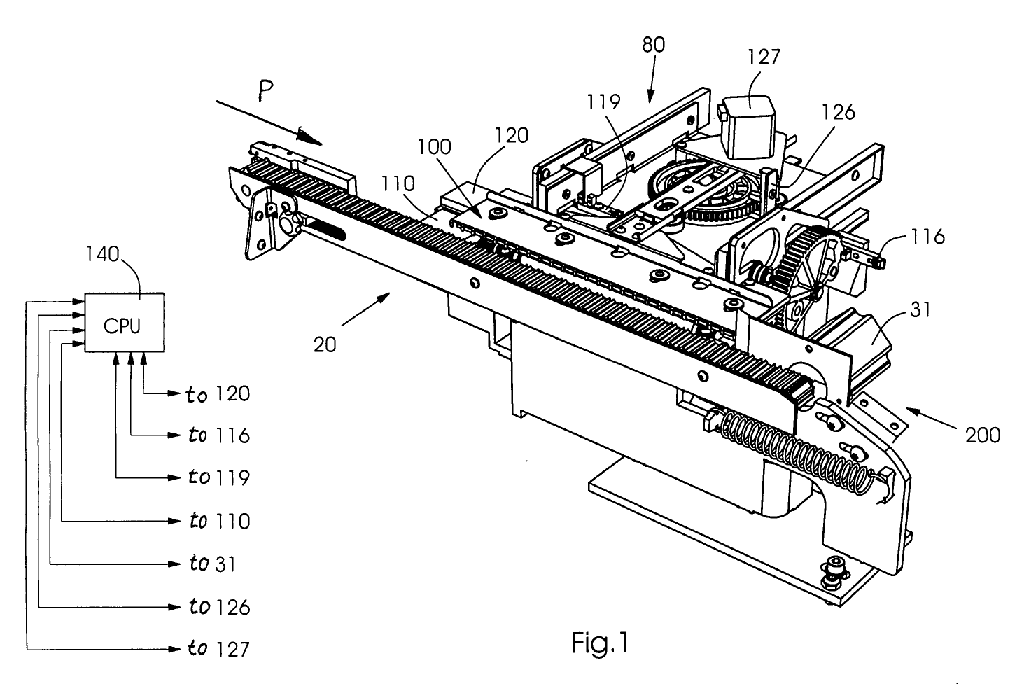

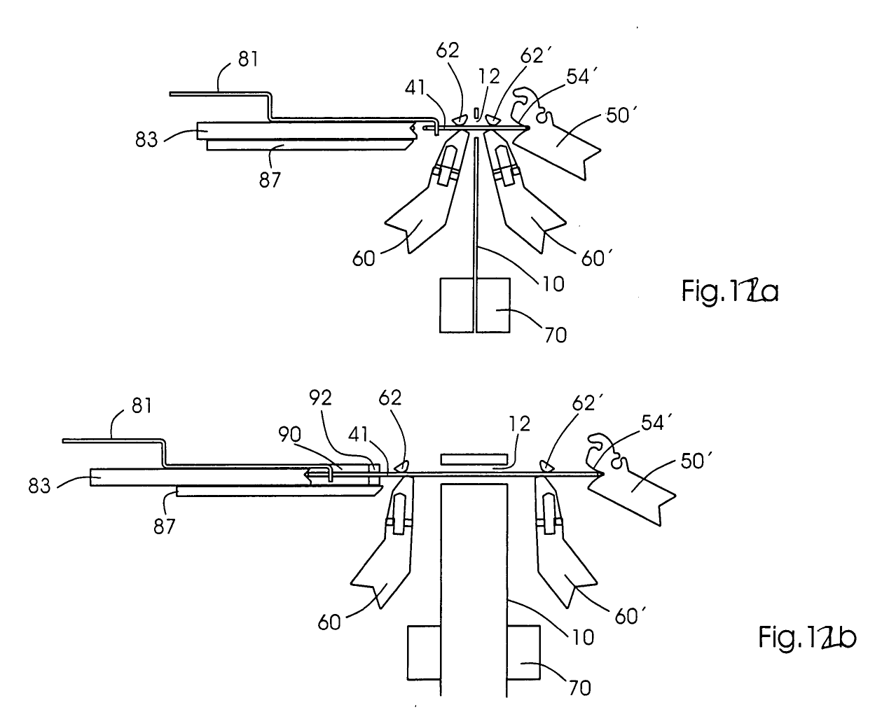

Various aspects of the invention are presented in FIGS. 1-12, which are not drawn to scale, and wherein like components in the numerous views are numbered alike. FIG. 1 shows the overall structure of a device 200 according to an aspect of the invention for handling wire binding element preforms of which, for the purpose of simplifying the description, only the components essential to the invention will be shown and/or explained. Other generally known drive and/or guiding means, control means and cams that are necessary for operating the device are only shown schematically and/or will only be described in a general way.

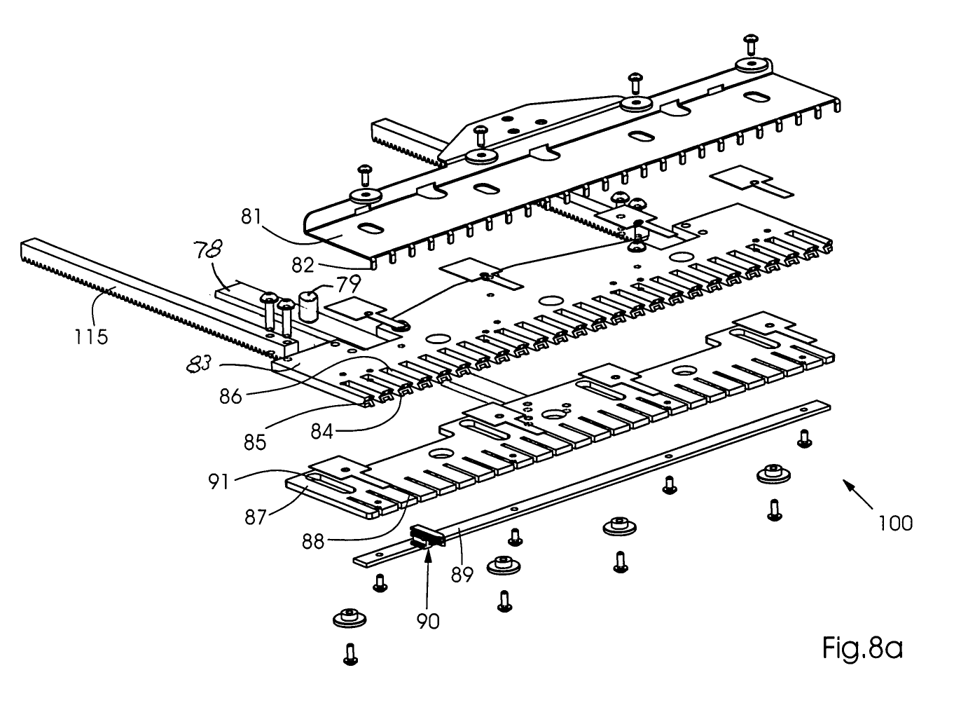

The device 200 comprises a transport unit 20 and an insertion unit 80, whereby the insertion unit 80 has an insertion module 100. The device 200 has a drive 31 for the transport unit 20, a drive 110 for a swivel movement, a drive 120 for a horizontal movement 120, and a drive 127 for insertion movement of the insertion module 100. The drives 31, 110, 120 and 127 are actuated by a control 140. The control 140 is also connected to the optical switches 116, 119, 126 and 27 (see FIG. 7). The control 140 can be part of a higher-level control that is not shown, which e.g. controls a higher-level device for binding brochures of different formats and thicknesses using wire comb binding. The control 140 can receive information from the higher-level control regarding the number N of the loops S of the wire binding element preform 41 and the length L of the loops S of the wire binding element preform 41. Alternatively, this information can also be input at a user interface, which is not shown, or by using a network with a control that is at a distance.

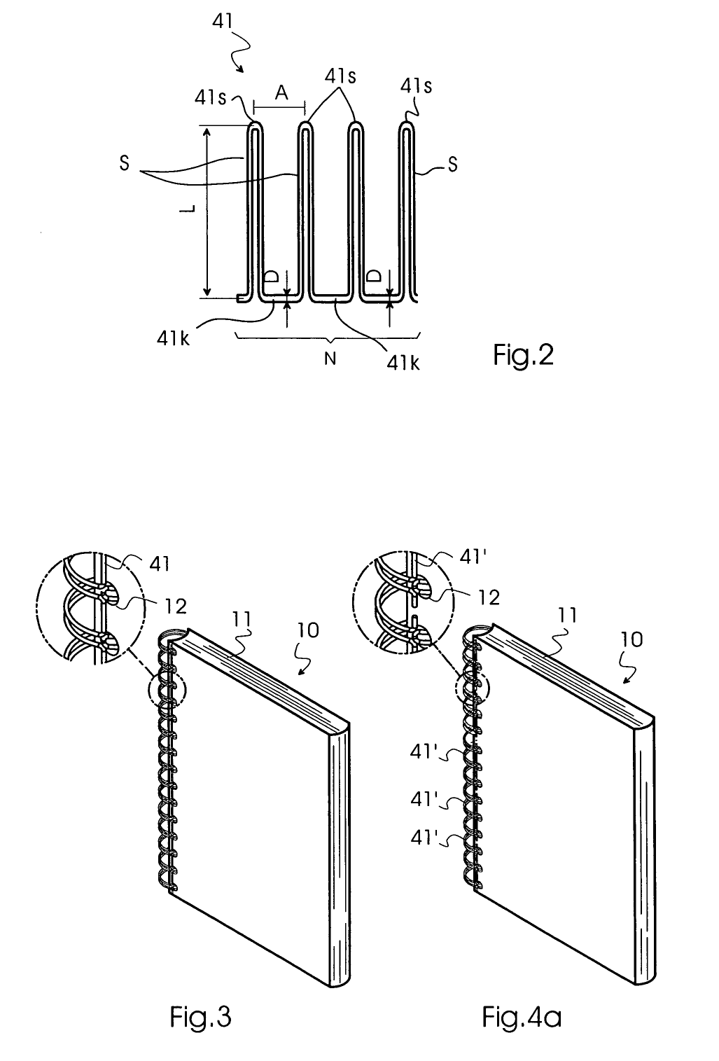

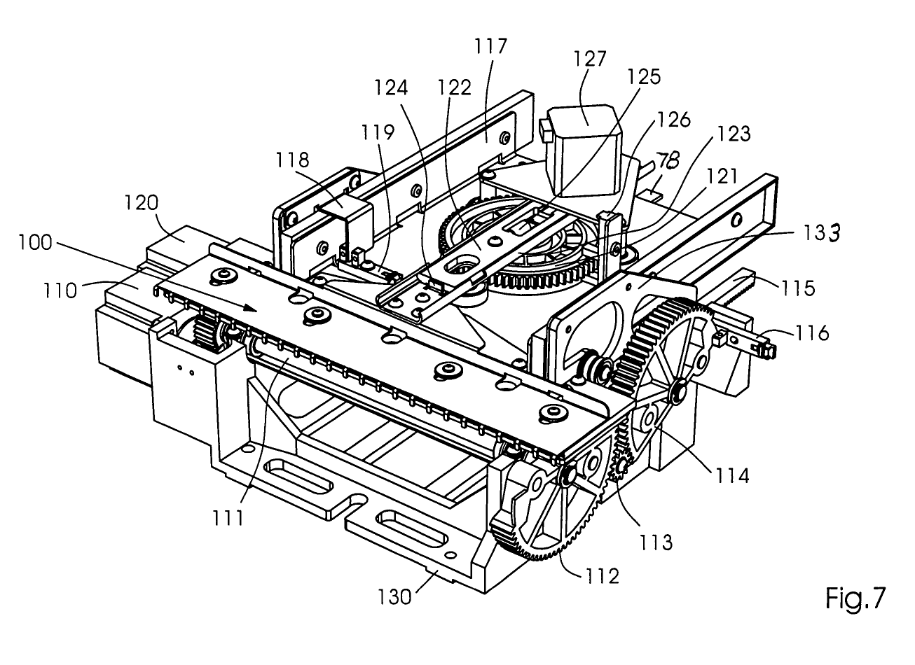

The transport unit 20 accepts a wire binding element preform 41 (see FIG. 2) from a unit, which is not shown, that makes the wire binding element preform 41 available in the intake area shown on the left in FIG. 1 (see FIG. 6). The wire binding element preform 41 is then transported by the transport unit 20 along the arrow marked with reference character P in transport direction to the insertion unit. There the wire binding element preform 41 is accepted by the insertion module 100 of the insertion unit 80 and inserted into the holes 12 of a stack of sheet-shaped materials 10 (see FIGS. 10-1 to 10-4).

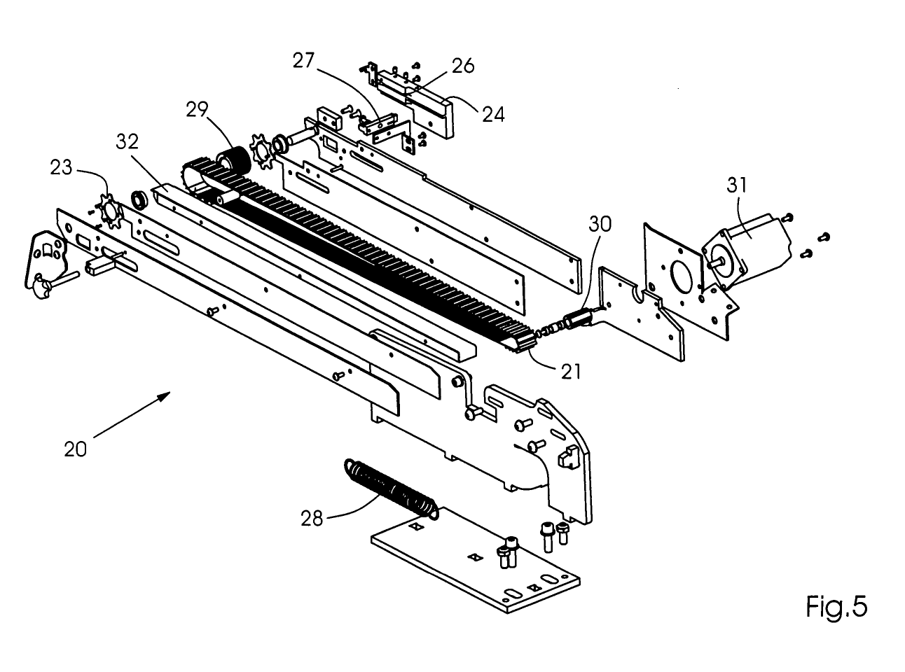

FIG. 2 shows a loop-shaped wire binding element 41 with four loops S. The loops S have a spacing A from loop tip 41s to loop tip 41s, and a wire diameter D, a loop length L and a number N of loops S. In addition, the wire base segments between the loops S are designated with reference characters 41k and the loop tips of the wire binding element 41 are indicated with the reference characters 41s. In this process, the spacing A corresponds to the spacing A′ of the holes 12 in the sheet-shaped material 11 (see FIG. 4b). The number of the holes N′ in the sheet-shaped material does not necessarily, as explained below, correspond to the number N of the loops S, rather it represents a maximum for the reasonable number N of the loops S of the wire binding element 41. For improved visual appearance, the wire binding element preform can have a colored plastic coating.

The loop length L specifies the diameter of the wire binding element 41 in closed O shape and can be made dependent on the number of sheet-shaped materials 11. The diameter of a wire binding element 41 bent to an O shape is selected in such a way that the bound brochures 10 have an aesthetic appearance, have pages that are easy to turn and can be stacked easily.

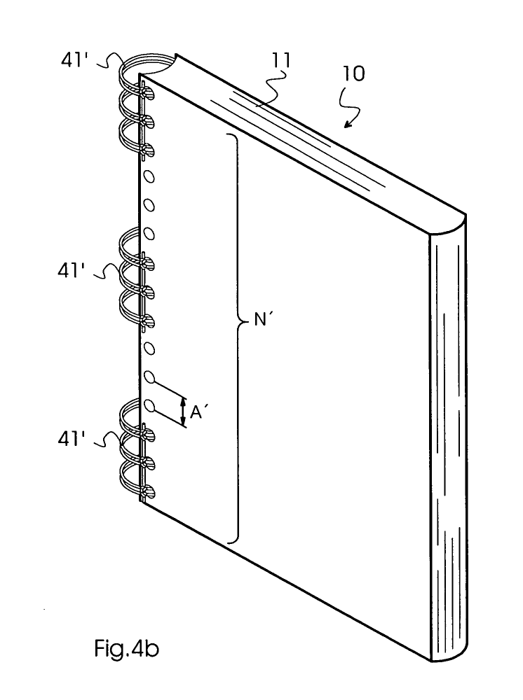

FIG. 3 shows a finished bound brochure 10 that has a uniform binding. FIG. 4a shows an individual binding that consists of wire binding elements 41′, each of which has only one single loop and is used for each hole 12 in the print carriers. FIG. 4b shows a wire comb binding that consists of several, e.g. multi-loop wire binding elements 41′ that are at a distances from each other so that holes 12 remain free. Any other combination of the options mentioned above is clear to the person skilled in the art.

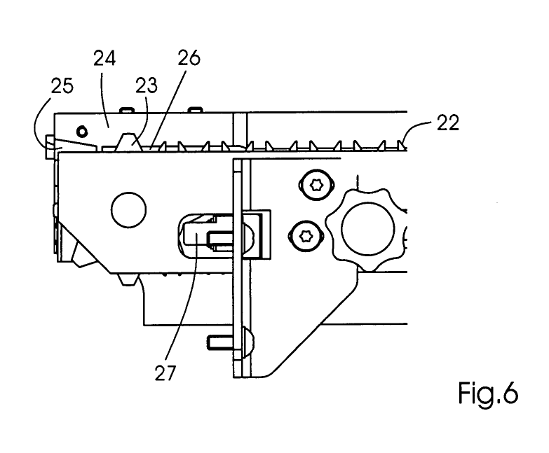

FIG. 5 shows an exploded view of the components in the transport unit 20. An endless transport belt 21 is stressed over a front belt roller 29 and a rear belt roller 30 by a spring 28. The transport belt is driven by the electric motor 31. A magnet unit 32 is mounted within the transport belt 21. In the embodiment shown, the magnet unit 32 is a permanent magnet. The permanent magnet of the magnet unit 32 has magnetizing that, on one hand, is high enough to create an adequate holding force to hold the wire binding element preform 41 on the transport belt 21 so that it will not slip and on the other hand, is low enough so that the insert unit 80 is able to loosen the wire binding element preform 41 from the transport belt 21. A star wheel 23 is mounted in the intake area of the transport unit 20, on the same axis as the belt roller 29. A wire base bracket 24 that has a registration groove 26 as the alignment segment 26 is also mounted there.

FIG. 6 shows an enlargement of the intake area of the transport unit 20. On its upper surface, the transport belt 21 has cams 22. The cams optionally have a chamfer and are at a distance from each other according to the distance A of the wire loops S. The chamfers of the cams 22 are used as an adjusting aid for the wire loops S during acceptance of the wire loops S from the preceding unit, which is not shown. Mounted to the side of the transport belt 21 is the wire base bracket that presses the wire base 41k of the wire binding element preform 41 laterally against the registration groove 26. In the intake area, the registration groove 26 expands to an intake funnel 25. This intake funnel 25 guides the first wire base segment 41k of a wire binding element preform 41 that has just been delivered, which, because of deformations of the wire binding element preform 41, is outside of the plane formed by the transport belt 21, against register groove 26.

The wire loops S are first gripped by the prongs of the star wheel 23 and guided in transport direction P on the transport belt 21 between the cams 22 of the transport belt. In this process, the chamfer on the prongs of the star wheels 23 directly covers the chamfer on the cams 22 of the transport belt. The position of the star wheel 23 is controlled by the optical switch 27, which sends the position information to the control 140.

As can be seen in FIG. 7, the drive 110 for the swivel movement drives, by way of a shaft 111, a first gear 112 that is in engagement with a second gear 113 that is in engagement with a third gear 114. The position of the third gear 114 is controlled by an optical switch 116 that is connected to the control 140. By means of the drive 110, the parallelogram plate 133 can be set into a swivel movement.

A carriage 117 is fastened on the parallelogram plate 133. The position of the carriage 117 is monitored by the optical sensor 119, into which a tab fastened on the parallelogram plate 133 extends according to the position of the carriage 117. The horizontal movement of the carriage 117 is driven by two racks 115. The drive motor 120 is stationary and acts on the pinion of the rack 115 by means of intermediate gears, of which two are located in the linkage points of the connecting plates 131. Because of this, no positioning movement is caused by the swivel movement of the parallelogram plate 133 during the horizontal movement of the carriage 117.

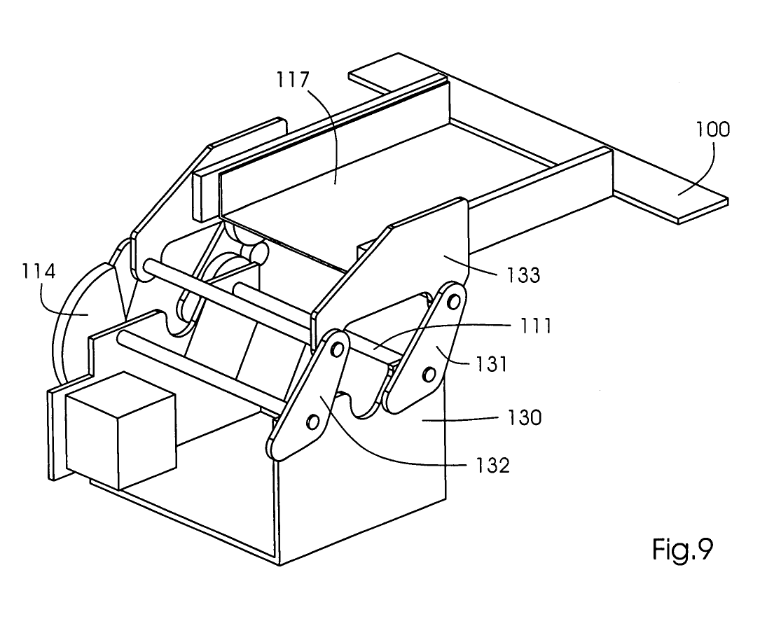

FIG. 9 shows the function method of the swivel movement, again schematically. A first connecting plate 131 and a second connecting plate 132 are connected to the parallelogram plate 133 and the housing 130. The swivel movement of the parallelogram plate 133, and thus the swivel movement of the carriage 117 that holds the insertion module 100, is such that the first connecting plate 131 and the second connecting plate 132 in the end position for insertion are located behind their slack point, as shown in FIG. 9. Because of the parallel movement of the first connecting plate 131 with respect to the second connecting plate 132, the horizontal alignment of the parallelogram plate 133 is maintained during the swivel movement.

During a reverse swiveling of the carriage from the position shown in FIG. 9, the carriage first lifts up to overcome the slack point so it can then be lowered again. If the portion of the reverse movement of the carriage 117 caused by the swivel movement is compensated by a forward movement of the carriage 117 (by a corresponding control), the insertion module 100 experiences a purely vertical movement, namely a lifting of the carriage until the slack point of connecting plates 131, 132 is reached and a subsequent lowering by a further swiveling of the connecting plates 131, 132. Advantageously, this stroke that is generated by the combined swivel movement and the excursion of carriage 117 is long enough to lift the rake fingers 82 over the plane of the wire binding element preform 41, for example after the wire binding element preform 41 has been inserted into the stack of sheet-shaped print materials.

On the carriage 117, a drive 127 is mounted for the “open”, “close” and “center” movements of the insertion module 100, which is in engagement with a toothed cam ring 121. The position of the toothed cam ring 121 is checked by an optical switch 126 that is connected to the control 140. Also in engagement with the toothed cam ring 121 is a push rod 122 that is pressed by a spring 125 against a stopper 124 of a rod guide 123. The rod guide 123 is connected to the rake plate 81.

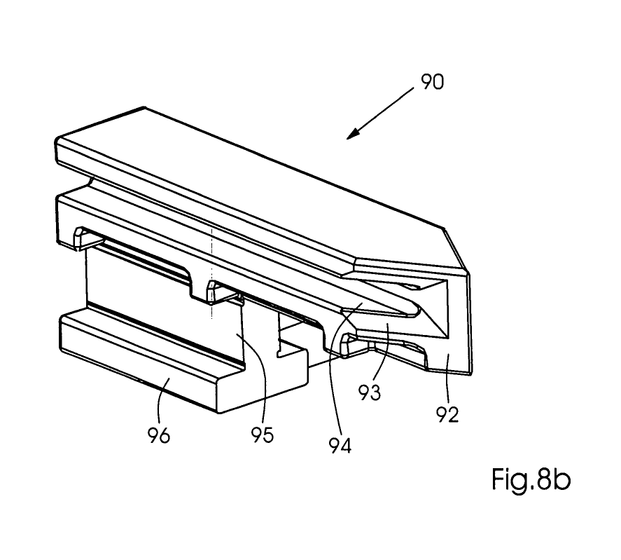

FIG. 8a shows an exploded view of the components of the insertion module 100. The racks 115 are fastened on a prism plate 83. At its open end, the prism plate 83 has a comb-like structure whereby notches 84 that match each other are provided on the tips of the prongs of the comb-like structure. These notches 84 are used as a supporting structure for the wire base segment 41k of each individual loop. Above the prism plate 83, the rake plate 81 is mounted in slots so that it can move. The rake plate 81 has a number N+1 of rake fingers 82, whereby the number N is the maximum number N of the loops S of a wire binding element preform 41 that will be handled with the device 200 according to the invention. Prism plate 83 and rake plate 81 are arranged with respect to each other in such a way that the rake fingers 82 are each arranged in the center of the notches 84 in the prism plate. The notches 84 in the prism plate 83 have, in their center, vertical grooves 85 that make it possible for the rake fingers to be moved far enough against the shanks of the notches 84 to ensure a secure gripping of the wire base segments 41k of a wire binding element preform 41. The flanks of the notches 84 are used as centering means for the wire base segments 41k.

Below the prism plate 83, a carrier plate 87 is connected to the prism plate 83 by slots 91 so that it can move. On its open end, the carrier plate 87 also has a comb-like structure, whereby prism plate 83 and carrier plate 87 are aligned laterally with respect to each other so that the grooves 88 come to rest centrally below the slots 86 of the comb-like structure of the prism plate 83. Wire loop support elements 90 are placed in the grooves 88 of the carrier plate 87.

The wire loop support elements 90 are shown enlarged in FIG. 8b. According to this, on the front, the wire loop support elements 90 have a wedge 92 that is positioned precisely in the center between two wire base segments 41k due to the positioning between the carrier plate 87 and the prism plate 83. The wedge 92 is used to align the wire base segments 41k along the wire base 41k. The wire loop support elements are inserted, with a T piece 95, into the grooves 88 of the carrier plate 87 and are secured against vertical displacement by the cross bars 96 of the T piece. The wire loop support elements 90 have, mirror symmetrically with respect to the center, three fixing surfaces 94 for three-sided fixing of wire loops S. After the insertion of the wire loop support elements 90 into the grooves 88 of the carrier plate 87, the wire loop supporting elements 90 are fastened to the carrier plate 87 with a fixing plate 89 so that they cannot slip.

By using suitable means, for example, a drive linkage 78 disposed beneath the carriage 117, the carrier plate 87 together with the wire loop support elements 90, can be slid along the slots 91 into the gaps 86 of the prism plate 83. If at this time the wire base 41k is already located in the notches 84 of the prism plate, which is held there by the rake fingers 82, the wire loop support elements slide into the wire loops S. The drive linkage 78 has a pin 79 that extends through a slot in the carriage 117 and engages a track in the underside of the toothed cam wheel so that movement of the drive linkage 78 is coordinated with movement of the rod 122.

In the following, the function of the device 200 according to the invention will be described using a wire binding element preform 41 that has been supplied. First the unit that supplies the wire binding element preform 41 makes two finished wire loops S in cycles. During this time, the transport unit 20 remains at rest. As soon as the first two wire loops S have bridged the intermediate space between the unit that makes the wire binding element preform 41 available and the transport unit 20 and have been caught by the first prong of star wheel 23, the first wire loop S of the wire binding element preform 41 is held by the star wheel 23 and guided between the cams 22 on the transport belt 21. The intake funnel 25 holds the first two wire loops S immediately as soon as they are transported out of the unit that makes the wire binding element preform 41 available. A magnet, which is not shown, that is present on the side of the mouthpiece, supports the linear alignment of the wire base 41k in that it pulls it against the lateral mouthpiece and bracket wall 26 even before they are held by the magnet of the transport belt and are then secured against shifting. In the following, all further wire loops S will be guided sequentially by the star wheel 23 between the cams 22 on the transport belt 21, where they are held fast because of the holding force of the magnet 32. The cams 22 on the transport belt 21 prevent lateral displacement of the wire loops S during transport and ensure parallel alignment of same.

As soon as the star wheel 23 has placed the wire loop S on the transport belt 21, the star wheel 23 and the transport belt 21 stop and wait for the next wire loop S. This procedure of placing the wire loop S on the transport belt 21, by way of the star wheel 23, repeats in cycles until the last wire loop S of the wire binding element preform 41 has been placed on the transport belt 21. As soon as the last wire loop S of the wire binding element preform 41 has been made available, in the embodiment that is preferred, namely in that the unit that makes the wire binding element preform 41 available is a unit that forms the wire binding element preform 41 immediately before that, the wire must be cut off after the last wire loop S. This is advantageously carried out in the unit that has formed the wire binding element preform 41 immediately before that.

As soon as the last wire loop S of the wire binding element preform 41 has been placed on the transport belt 21, a fast feed is used to transport the wire binding element preform 41 to the insertion unit 80. The insertion unit lowers the insertion module 100 far enough so that the rake fingers 82 of the rake plate 81, which at this moment are at a distance from the notches 84 of the prism plate 83, dip into the intermediate space between the transport belt 21 and the wire base segments 41k (the insertion unit 100 having already been disposed just above the wire binding element preform 41). The toothed cam wheel 121 is rotated which pulls the rod 122 back along with the rake plate 81. Because of this reverse movement of the rake plate 81, the rake fingers 82 are brought into contact with the wire base segments 41k and together with them are pressed into the notch 84 of the prism plate 83.

Next, the wire loop support elements 90 are slid into the wire loops S simultaneously with a reverse movement of the carriage 117 by way of the racks 115. The wire loop support elements 90 are slid into the wire loops S by further rotation of the toothed cam wheel 121, which drives the drive linkage 78 forward via the pin 79. The drive linkage 78 is mounted to the carrier plate 87. In this way the wire loops S are fixed tightly in such a way that a vertical lifting of the wire loops S from the transport belt 21 is possible. After the wire binding element preform 41 has been lifted from the transport belt 21 by rotation of the gears 112, 113, 114, the transport unit 20 is ready to accept the next wire binding element preform 41 (reverse rotation of the toothed wheel 121 returns the rake plate 81 and carrier plate 87 to their original positions).

Further rotation of the gears 112, 113, and 114 raises the carriage 117 over the slack point and forward to the position shown in FIG. 9. The wire binding element preform 41 is now ready for the insertion sequence.

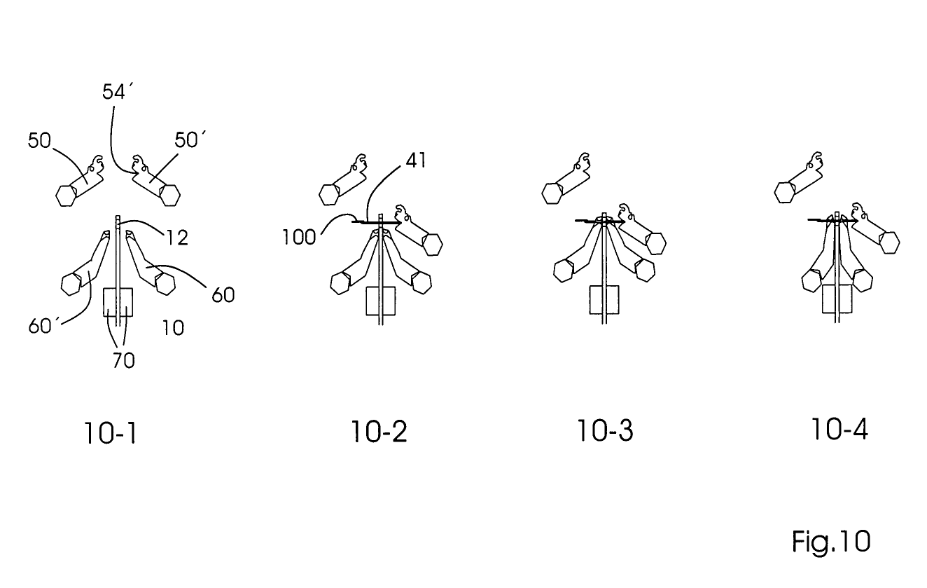

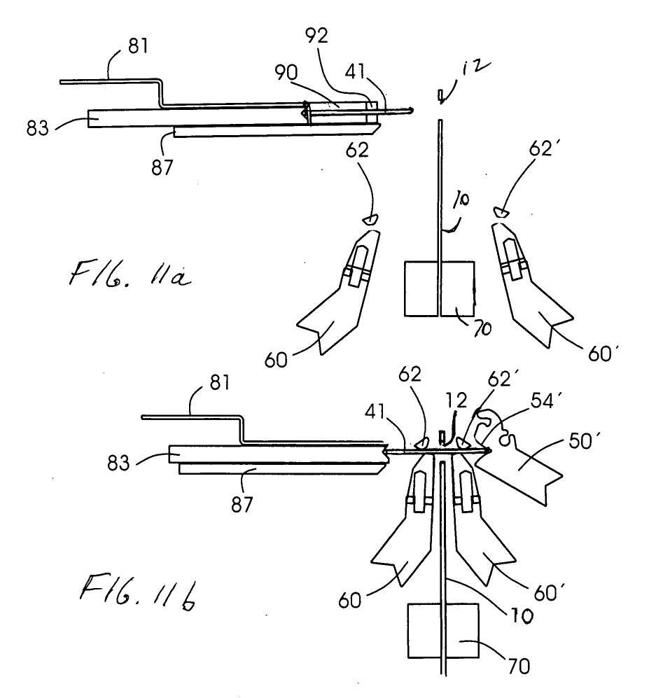

The further movement sequence of the insertion will be described using FIGS. 10-1 to 10-4 with reference to FIGS. 11a and 11b. In FIG. 10-1, the device according to the invention is found in a base position. As best shown in FIG. 11a, a stack of sheet-shaped materials 11 with aligned holes 12 are clamped in tongs 70 in such a way that the holes 12 of the sheet-shaped materials 11 are located in an insertion plane for the wire binding element preform 41. Referring again to FIG. 10-1, C formers 50, 50′ are located above the insertion plane, O formers 60, 60′ are located below the insertion plane.

Referring now to FIG. 2, the C formers 50, 50′ are then set at a distance from each other that corresponds to the thickness of the brochure 10 to be bound, in such a way that in the position assumed by the tongs 70, they act to prevent fanning out of the sheet-shaped materials 11, especially if the tongs 70 swivel sheet-shaped materials 11 from below into the planned position. Because of this, individual sheet-shaped materials that have spread out are aligned.

Once the sheet-shaped materials 11 are found at the planned position, the second C former 50′ moves downward into the centering position for the flat loop-shaped wire binding element 41 as shown in FIG. 10-2. The second C former is located in the centering position when the centering funnel 54′ of the second C former 50′ is aligned with the holes 12 of the sheet-shaped materials 11.

After that, the carriage 117 is driven forward to insert the flat wire binding element preform 41 through the holes 12 in the sheet-shaped materials 11 up to the stop with the tips 41s in the centering funnel 54′ of the second C former 50′, as shown in FIG. 11b. The carriage 117 is driven forward by way of the racks 115, but before that, the wire loop support elements 90 are withdrawn by reverse rotation of the toothed cam wheel 121. In this position, the flat wire binding element preform 41 is still fixed in this position by the insertion unit 100.

As a deviation, there can also be a number of flat wire binding elements preforms 41 as described above and as shown in FIG. 4a and FIG. 4b. For the sake of simplicity, in the following, a single flat wire binding element preform 41 will be assumed, although a number of flat wire binding element preforms 41 do not represent any modification to the device according to the invention or to the inventive method.

In the next step, which is shown in FIG. 10-3, the O formers 60, 60′ move up in Y direction and dip down between the loops S of the flat wire binding element preform 41. Then the O formers 60, 60′ move in X direction to the correct contact point for a C shape of the wire binding element 41″ that first has to be produced. This C shape that first has to be produced depends especially on the loop length S and thus in turn on the diameter of the finished O shape and thus on the thickness of the brochure 10 to be bound. After that, the O formers 60, 60′ move in Z direction with their tabs 62, 62′ over the loops S until the tabs 62, 62′ cover the width of loops S.

As FIG. 10-4 shows, the O formers 60, 60′ then clamp the wire binding element 41 by rotation, around a point of rotation, which is not shown, toward the brochure 10. Up to this time, the tips 41s of the flat wire binding element preform 41 are at the stop in the centering funnel 54′ of the second C former. As soon as the wire binding element preform 41 is clamped in this position by the O formers 60, 60′, the insertion unit 100 releases the wire base by further reverse rotation of the toothed cam wheel 121 (thereby moving the rake plate 81 forward), since the wire binding element 41′ is fixed precisely in position by the C formers 50, 50′ or the O formers 60, 60′ for the further procedure of O forming.

The carriage 117 is now in the position shown in FIG. 9. During a reverse swiveling of the carriage 117 the carriage first lifts up to overcome the slack point so it can then be lowered again. The reverse movement of the carriage 117 caused by the swivel movement is compensated by a forward movement of the carriage 117 (by a corresponding control), the insertion module 100 experiences a purely vertical movement, namely a lifting of the carriage until the slack point of connecting plates 131, 132 is reached and a subsequent lowering by a further swiveling of the connecting plates 131, 132. The stroke that is generated by the combined swivel movement and the excursion of carriage 117 is long enough to lift the rake fingers 82 over the plane of the wire binding element preform 41. The carriage 117 may then be returned to its initial position where it is ready to repeat the process.

The insertion unit may comprise exactly one insertion module to insert the flat wire binding element preforms into the row of perforations in a stack of sheet-shaped materials. This is especially advantageous if the wire binding element preform has a number of wire loops that are to be inserted in the stack of sheet-shaped materials that is equal to the number of holes. In alternative applications, wire binding element preforms can be used that have a number of wire loops that is less than the number of holes in the stack of sheet-shaped materials. In this case, several wire binding element preforms can be inserted adjacent to each other in the row of perforations of a stack of sheet-shaped materials, if necessary at different distances from each other. In this case, the insertion unit can comprise several parallel insertion modules that operate synchronously or asynchronously. It is also conceivable that the majority of wire binding element preforms are sequentially inserted into the holes of a stack of sheet-shaped materials and the individual wire binding element preforms can be assigned and inserted in the holes of the stack of sheet-shaped materials by suitable means. In addition, a relative movement in the direction of the row of perforations can be provided between the insertion unit and the stack, either by movement of the insertion unit or movement of the stack.

The transport unit may have an endless transport belt. This transport belt may be advantageously made of flexible, low-wear plastic. In a device for flexible binding of book blocks or brochures of different thicknesses using wire comb binding, wire binding element preforms with different loop lengths L are prepared. The width of the transport belt may be coordinated to the loop length L of the wire binding element preforms in such a way that the wire binding element preforms with the shortest loop lengths L extend over the transport belt laterally on one side with the wire base and on the other side with the wire loop tip, whereby the lateral projection of the wire loop tip is not absolutely necessary. A link chain that is equipped with small spring-loaded wire holders is conceivable as a transport element.

The wire base may come to rest at a specified distance outside the transport belt. Because of this, a secure acceptance of the wire binding element preform located on the transport belt by the insertion unit can be ensured.

The transport unit belt may have teeth that support an alignment of the wire loops because of their geometry. In this way, the wire loops are aligned so that they lie essentially parallel to the teeth on the transport belt. The parallel alignment of the wire loops with respect to each other is especially important since the wire loops will be inserted through parallel holes in the stack of sheet-shaped materials. In addition, because of the parallel alignment, there is adequate contact between the wire loops and the transport belt. The teeth may have alternating chamfers that guide the wire loops into the intermediate spaces between the teeth, whereby the alignment of the wire loops is improved during the acceptance of the wire binding element preform from the unit that makes the wire binding element preform available. The teeth are at a distance from each other that essentially corresponds to the width of the wire loops.

Within the endless transport belt, magnets may be arranged that attract the flat wire binding element preform to the transport belt. This leads to a further improvement of the adhesion of the wire loops on the transport belt. The holding force of the wire loops caused by the magnets on the transport belt is set high enough so that the wire loops of the wire binding element preform can also be held securely to prevent deformation of the wire binding element preform. Deformation in this case is understood to mean the deviation of the shape of the wire binding element preform from the ideal shape of the wire binding element preform. A deformation such as this is present, for example, if the wire base describes a curve shape. A curve shape such as this is caused by the total of the angular deviations of the individual bending points in the wire binding element preform. Because of this, either the wire loop tips spread apart or are pressed together. On the other hand, the deformation may also be a case of twisting of the wire binding element preform, i.e. a screw-like deformation of the wire binding element preform. Deformations such as this can occur because of the storage of the wire binding element preform or due to the production of the wire binding element preform itself.

In addition, the holding force of the magnets may be at least high enough so that the wire loops do not slip while they are subjected to considerable acceleration and deceleration forces during transport on the transport belt. The considerable acceleration and deceleration forces may occur because the transport unit receives the wire binding element preform loop by loop. The transport unit must always move forward by one increment in the cycle of the device that makes the wire binding element preform available to the unit.

This may be especially necessary if the unit that makes the wire binding element preform available produces the wire loops individually in advance. In order to be able to ensure economical operation of a device for binding brochures of different sizes, typically high cycle frequencies are necessary, which leads to the necessity that the wire loops on the transport belt be accelerated correspondingly quickly and braked again.

On the other hand, the holding force of the magnets must be be low enough so that the insertion unit downstream of the transport unit is able to lift the wire binding element preform from the transport unit. This is especially necessary if it is a case of a permanent magnet. In an alternative embodiment, the magnet is an electromagnet that can be switched on and off with a control. In comparison to electromagnets, permanent magnets are preferred since, on one hand, they are less expensive and on the other, they require neither a power supply nor other electronics for control. In addition, the holding force of the magnets can be optimally adjusted because of the magnetizing of the magnets, by the width of the transport belt and by the spacing of the magnetic system with respect to the wire loops on the transport belt.

The transport unit may have a star wheel that guides the flat wire binding element preform onto the transport base. Because of this, the rounding in the intake area of the transport belt in particular can be bridged since the star wheel at this point extends past the transport belt in the direction of the unit that makes the wire binding element preform available.

A wire base bracket may be provided in the intake area of the transport unit that aligns the wire base laterally in order to achieve the specified lateral spacing of the wire base with respect to the transport belt. This precise lateral registration of the wire binding element preform may be important so that the further procedures, especially the acceptance and the insertion by the insertion unit, are ensured so that they are reproducible. In addition, because of their manufacturing, the wire loops come out of the device that makes a flat wire binding element preform available with a certain deviation from the specified path. Advantageously, therefore, the wire base bracket has an intake funnel that guides the wire base to an alignment segment within the bracket. This intake funnel proves to be advantageous, especially when the first wire loop of a wire binding element preform will be grasped by the transport unit.

In an embodiment in which the device according to the invention takes the wire binding element preform over from a unit that produces the wire binding element preform immediately before that and transfers it to the device according to the invention, during the production of the first two loops the transport belt is at first stopped in order to move synchronously with the working cycle of the preceding unit during the third wire loop. This is advantageous since in this way the start of the wire binding element preform cannot catch in the star wheel and is held on the uppermost prong at the correct distance so that because of this, larger distances between the wire loops due to production can nevertheless be grasped by the star wheel and pressed into the intermediate spaces of the transport belt. Due to production, distances between the wire loops that are too large typically occur more frequently than distances between the wire loops that are too small. If in contrast to the procedure described above, the star wheel would move synchronously at the time the first loops were made, the threading would be made considerably more difficult. After the first wire loop of the wire binding element preform is placed on the transport belt, the second and every other following wire loop of the wire binding element preform is already held by the transport unit and, therefore, generally barely deviates from the specified path.

The insertion unit may have a rake plate, whereby the rake plate has vertical rake fingers that are spaced regularly, whereby the spacing of the rake fingers essentially corresponds to the wire loop spacing. If the insertion unit is designed as one piece, the number of rake fingers on the rake plate corresponds to the maximum number of holes that are provided in the stack of sheet-shaped materials, i.e. designed for the largest format of stacks of sheet-shaped materials to be processed. In an insertion unit made of several parts, the rake plate has at least as many rake fingers as the longest wire binding element preform to be processed has wire base segments.

In another advantageous design of the device according to the invention, the transport unit guides the flat wire binding element preform into the insertion unit in such a way, that the rake fingers are assigned to the wire base segments, so that the center of each rake finger essentially coincides with the center of the each wire base segment.

The insertion unit may have a prism plate that has notches that are assigned to the wire base segments and are aligned with them. Rake fingers and prisms in the prism plate make possible a three-point holding of the wire base segments of the wire binding element preform. The matching notches define the plane in which the wire binding element preform is located if it is handled by the insertion unit after that.

The transport unit has movable wire loop support elements that may support the wire loops in a defined manner during handling by the insertion unit. The wire loop support elements are especially advantageous if wire loops with long length are involved, i.e. with wire binding element preforms for books with many pages. Because of the wire loop supporting elements, it can be ensured that the wire loop tips are located at the same height as the wire base. This may be necessary in order to be able to ensure reliable insertion of the wire loop tips into the holes of the stack of sheet-shaped materials independently of format, i.e. independently of the length of the wire loops.

The rake plate, the prism plate and the wire loop supporting elements may be connected so that they can move as one insertion module, and this insertion module is mounted, driven and controlled so that the insertion module can move the wire binding element preform horizontally and vertically, parallel to the wire base. In particular, the horizontal and vertical movement of the wire binding element preform, parallel to the wire base, results from a superimposed swivel movement and a horizontal movement of the insertion module. In this process, the radius of the swivel movement essentially corresponds to the difference in height to be overcome between the plane in which the wire binding element preform is located on the transport unit and the plane in which the holes in the stack of sheet-shaped materials are located. Because of the swivel movement, this height difference can be reproduced in a simple and precise manner.

The rake fingers may dip essentially vertically behind the wire base of the wire binding element preform on the transport belt and then pull the wire binding element preform essentially horizontally toward the back into the prisms of the prism plate. In this process, the wire binding element preform is only pushed a slight distance in comparison to loop length L in order to be able to prevent damage to the wire binding element preform or to the coating of the wire binding element preform. The vertical movement of the rake fingers may be achieved by superimposing the swivel movement and the horizontal movement in the insertion module.

After the wire base is fixed between the wire fingers and the prisms, the wire loop support elements may be moved into the loops of the wire binding element preform. For this purpose, the wire loop support elements have three-sided fixing surfaces in lengthwise direction that are adapted to the wire diameters and are at a distance from each other that corresponds to the width of the wire loops. In this way, a three-sided support of each shank of a wire loop can be achieved. The length of the wire loop supporting elements here is adapted to the shortest length of the wire loops of the wire binding element preform that will be handled by the device according to the invention.

The wire binding element preform may be lifted vertically from the transport unit. Because of this, the wire binding element preform can be removed from the transport unit with the least possible damage.

The device has a control that adapts the forward movement of the transport unit to the cycle frequency of the upstream device. In this case, in a preferred embodiment it is a mechanical step-by-step motion linkage with a summarizing gear that is linked to the unit that makes the wire binding element preform available loop by loop. In this way, it is possible to implement the operating conditions “stop,” “transport in cycles” and “fast transport independently of cycle.”

In addition, the present invention relates to a method for handling flat wire binding element preforms, whereby the flat wire binding element preforms have wire loops that are at a wire loop space from each other and have a wire loop length and wire loop tips and whereby the wire loops are connected to each other by a straight wire base segment, whereby the wire base segments of the wire binding element preform essentially match each other with the following steps:

Acceptance of the flat wire binding element preform by means of a transport unit, transfer of the flat wire binding element preform to an insertion unit, insertion of the flat wire binding element preform into a row of perforations in a stack of sheet-shaped materials.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

We claim:

1. A device, comprising:
a transport unit for accepting and transporting a flat wire binding element preform;
an insertion unit for inserting flat wire binding element preforms into a row of perforations in a stack of sheet-shaped print materials.

2. The device of claim 1, the transport unit comprising an endless transport belt.

3. The device of claim 2, the transport belt comprising cams (22) that support an alignment of wire loops in the flat wire binding element preforms.

4. The device of 2, comprising magnets are arranged inside the endless transport belt that pull the flat wire binding element preform onto the transport belt.

5. The device of claim 2, the transport unit having a star wheel that guides the flat wire binding element preform onto the endless transport belt.

6. The device of claim 2, comprising a wire base bracket that aligns the wire base laterally in order to achieve a specified lateral distance of the flat wire binding element preform relative to the endless transport belt.

7. The device of claim 1, the insertion unit having a rake plate having vertical rake fingers that are spaced regularly to be placed in the interstices between loops of the flat wire binding element preform.

8. The device of claim 1, the insertion unit comprising a prism plate that has notches configured to align with a base of the flat wire binding element preform.

9. The device of claim 1, the insertion unit comprising movable wire loop supporting elements that support wire loops in the flat wire binding element preform.

10. The device of claim 1, the insertion unit comprising a rake plate, a prism plate and wire loop supporting elements, the rake plate, connected so that they can move to form an insertion module;
the insertion unit being mounted, driven and controlled in such a way that the insertion module can move the flat wire binding element preform horizontally and vertically parallel to a base of the flat wire binding element preform.

11. The device of claim 10, wherein the horizontal and vertical movement of the wire binding element preform parallel to the wire base result from a superimposed swivel movement and horizontal movement of the insertion unit.

12. The device of claim 10, wherein the rake fingers dip vertically behind the wire base segments and then pull the wire binding element preform horizontally toward the rear into the notches of the prism plate.

13. The device of claim 10, wherein after the fixing of the wire base in the notches, the wire loop supporting elements are moved into the wire loops of the wire binding element preform.

14. The device of claim 1, the where the transport unit vertically raises the flat wire binding element preform.

15. The device of claim 1, comprising a control that adapts forward movement of the transport unit to the cycle frequency of an upstream device.

16. A method for handling flat wire binding element preforms, comprising:
accepting a flat wire binding element preform with a transport unit;
transfering the flat wire binding element preform to an insertion unit;
inserting the flat wire binding element preform into a row of perforations in a stack of sheet-shaped materials.

17. A method, comprising:
accepting a flat wire binding element preform from a feed;
transporting the flat wire binding element preform; and
inserting the flat wire binding element preforms into a row of perforations in a stack of sheet-shaped print materials.

18. The method of claim 17, comprising inserting the flat wire binding element preform with an insertion unit; and,
superimposing a swivel movement and horizontal movement of the insertion unit to achieve a vertical movement of the flat wire binding element preform.

19. The method of claim 17, comprising inserting the flat wire binding element preform with an insertion unit; and,
controlling the insertion unit to move the flat wire binding element preform horizontally and vertically parallel to a base of the flat wire binding element preform.

20. The method of claim 17, comprising inserting the flat wire binding element preform with an insertion unit; and,
moving the insertion unit in two orthoginal directions.
